(19) United States
(12) Patent Application Publication
(10) Pub. No.: US 2005/0030089 A1
(43) Pub. Date: Feb. 10, 2005

(54) Controlled switch of the switched capacitance type

(75) Inventors: Gabriele Gandolfi, Siziano (IT); Andrea Baschirotto, Tortona (IT); Vittorio Colonna, Landriano (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.r.l., Agrate Brianza (IT)

(21) Appl. No.: 10/766,521

(22) Filed: Jan. 27, 2004

(30) Foreign Application Priority Data
Jan. 30, 2003 (IT) MI2003A000154

(51) Int. Cl. G05F 3/02

(52) U.S. Cl. 327/537

(57) ABSTRACT

A controlled switch of the switched capacitance type is disclosed. In one embodiment the controlled switch comprises a control circuit for the switch, in a first phase the controlled circuit closes the controlled switch, in a second phase the control circuit opens the controlled switch, the controlled switch comprises a MOS transistor having a source and a substrate, characterized in that in the first phase the substrate is coupled to ground and in the second phase the substrate is coupled to the source.

### BACKGROUND OF THE INVENTION

1. Field of the Invention

The present invention refers to a controlled switch of the switched capacitance type.

2. Description of the Related Art

When the distortion of a switching capacitance system is an important design parameter, it is necessary to improve the linearity of the switches, especially when the signal frequency is near the sampling frequency and even more when the sampling frequency is near the available technology limit.

For example, if a digital-analog converter of the Sigma Delta type with a working frequency of 10.7 MHz and a sampling frequency of 37.05 MHz is considered, 70 dB of intermodulation distortion (IMD) are required for two signals of amplitude equal to −11 dB (0 dB are equal to 4 differential Vpp) and of frequency respectively equal to 10.6 MHz and 10.8 MHz. In this case all the switches, with switched capacitors, connected to the inputs and to all the signals that must have an elevated swing (for example at the output of the operational amplifiers) they have to be carefully designed in order to get the desired performances.

Up to now three strategies for improving the linearity of the switches have been used.

The use of complementary MOS transistors, that is of an NMOS transistor in parallel with a PMOS transistor, having an appropriate dimensional relationship between each other because of the different mobility of the two types. In this way a more symmetrical and linear characteristic of the current I related to the voltage V is obtained in comparison with a single transistor, however it is not yet enough for the desired performances.

The insertion of a resistance in series with the switch gives good results if the resistance is negligible in comparison with the total resistance with a ratio of at least 10 times. In order to have a total resistance of about 50 ohm, the added resistance has to be smaller than 5 ohm, and so the dimensions of the whole switch become enormous and not practicable.

The use of controlled switches of the boosted type has the particularity that the voltage between gate and source is constant independently from the input so that the characteristic I toward V is constant at a first order. A second order effect of this structure is the modulation of the resistance due to the voltage between the substrate and the source that changes with the applied signal.

### BRIEF SUMMARY OF THE INVENTION

One embodiment of the present invention provides controlled switches that have a resistance modulation which is reduced in comparison with the known art.

One embodiment of the present invention provides a controlled switch comprising a control circuit for the switch, in a first phase the control circuit opens the controlled switch, in a second phase the control circuit closes the controlled switch, the controlled switch comprises a MOS transistor having a source and a substrate, characterized in that in the first phase the substrate is coupled to ground and in the second phase the substrate is coupled to the source.

### BRIEF DESCRIPTION OF THE SEVERAL VIEWS OF THE DRAWING(S)

The features and the advantages of the present invention will be made more evident by the following detailed description of a particular embodiment, illustrated as a non-limiting example in the annexed drawings, wherein:

FIG. 1 shows a schematic circuit of a controlled switch with switched capacitance;

FIG. 2 shows a schematic circuit of an improved controlled switch with switched capacitance.

### DETAILED DESCRIPTION OF THE INVENTION

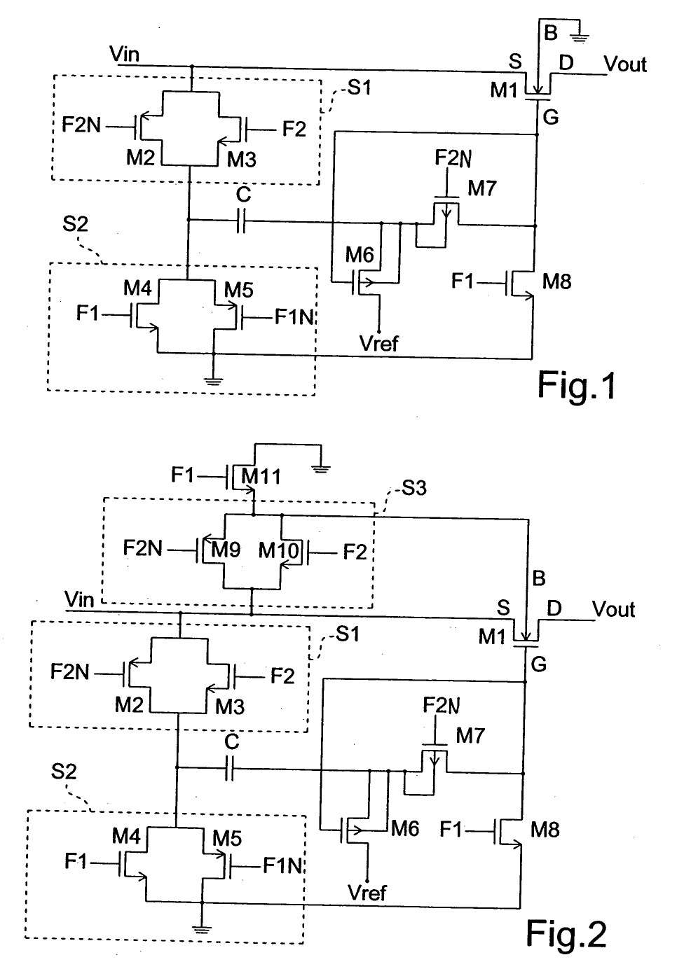

Referring to FIG. 1, the input voltage Vin is applied to the source S of an NMOS transistor M1 and the drain D of the transistor M1 supplies the output voltage Vout. A bulk terminal B connected to the bulk of the substrate of the transistor M1 is connected to ground. The input voltage Vin is also applied to a switch S1 comprising a pair of complementary transistors connected in parallel, that is an NMOS transistor M3 and a PMOS transistor M2. The drain of M3 is connected to Vin and to the source of M2. The source of M3 is connected to the drain of M2, to a terminal of a capacitor C and to a switch S2 comprising a pair of complementary transistors connected in parallel, that is an NMOS transistor M4 and a PMOS transistor M5. The drain of M4 is connected to the source of M5. The drain of M5 is connected to the source of M4 and to ground. The gate of M2 receives in input the control signal F2N, the gate of M3 receives in input the control signal F2, the gate of M4 receives in input the control signal F1, the gate of M5 receives in input the control signal F1N.

The other terminal of the capacitor C is connected to the bulk terminal and to the source of a PMOS transistor M6, and to the bulk terminal and to the source of a PMOS transistor M7. The drain of the transistor M6 is connected to a reference voltage Vref. The gate of the transistor M6 and the drain of the transistor M7 are connected to the gate G of the transistor M1 and to the drain of an NMOS transistor M8, whose source is connected to ground. The gate of M7 receives in input the control signal F2N, the gate of M8 receives in input the control signal F1.

The transistors are controlled by a square wave signal F1 with its negated signal F1N, and by a square wave signal F2 with its negated signal F2N. The signal F1 and the signal F2 are out of phase of 180° and moreover they have a delay between the two square waves so as to avoid the turning on of a transistor when those controlled by the other signal have not been turned off yet.

During the phase 1, that is when the signal F1 is active, the switches M1, S1 and M7 are turned off (open switches), and the switches S2, M6 and M8 are turned on (closed switches), therefore the capacitor C charges itself to the voltage Vref.

During the phase 2, that is when the signal F2 is active, the switches S2, M6 and M8 are turned off (open switches), and the switches M1, S1 and M7 are turned on (closed switches), therefore the gate G of the transistor M1 is supplied at a voltage equal to Vin plus the voltage Vref. In this way the voltage Vgs between the gate and source of the transistor M1 is always Vref without any influence by the input voltage Vin. The substrate of the transistor M1 is connected to ground to avoid that some diodes are directly biased.

It can be noticed that the resistance Ron of the transistor M1 changes in comparison with the input voltage. In the case of a transistor M1 having W=30 μm and L=0.36 μm, the resistance is about 82.8 ohm when the voltage between the bulk and source Vbs is equal to zero and about 111 ohm when the voltage Vbs is equal to 3.3 V.

A 30% variation cannot be compatible with some design requirements.

In FIG. 2 a schematic circuit of an improved controlled switch is shown.

Therein the bulk terminal B of the transistor M1 is not connected to ground but it is connected to a switch S3 comprising a pair of complemeritary transistors connected in parallel, that is an NMOS transistor M10 and a PMOS transistor M9. The drain of M10 is connected to the bulk terminal B of M1, to the source of M9 and to the source of a NMOS transistor M11. The source of M10 is connected to the drain of M9, and to the source S of M1. The drain of M11 is connected to ground.

The gate of M9 receives in input the control signal F2N, the gate of M10 receives in input the control signal F2, the gate of M11 receives in input the control signal F1.

During the phase 2, the switch S3 is turned on (closed) and the switch M11 is turned off (open), therefore the bulk terminal B of the transistor M1 is connected to the input voltage Vin (and to its source S), in this way the resistance Ron is not influenced by the modulation of the substrate B.

During the phase 1, the switch M11 is turned on (closed) and the switch S3 is turned off (open), therefore the substrate B of the transistor M1 is connected to ground. In this way the direct bias of the diodes between drain and substrate and between source and substrate is avoided when the transistor M1 is turned off.

Preferably, the system improves further (the so-called clockfeedtrough is reduced) by using a system with eight phases.

All of the above U.S. patents, U.S. patent application publications, U.S. patent applications, foreign patents, foreign patent applications and non-patent publications referred to in this specification and/or listed in the Application Data Sheet are incorporated herein by reference, in their entireties.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A controlled switch comprising:
a control circuit for said switch, in a first phase said controlled circuit opens said controlled switch, in a second phase said control circuit closes said controlled switch; and
a MOS transistor having a source and a bulk, wherein in said first phase said bulk is electrically coupled to ground and in said second phase said bulk is electrically coupled to said source.

2. The controlled switch according to claim 1 wherein in said first phase a first control signal is present and in said second phase a second control signal is present.

3. The controlled switch according to claim 2 wherein in said first phase said bulk is coupled to ground by a switch controlled by said first control signal.

4. The controlled switch according to claim 2 wherein in said second phase said bulk is coupled to said source by a switch controlled by said second control signal.

5. The controlled switch according to claim 2 wherein said MOS transistor has the source connected to an input voltage and a drain connected to an output voltage, said control circuit comprises a first switch controlled by said second control signal, applied between said input voltage and a first terminal of a capacitor, a second switch controlled by said first control signal, applied between said first terminal of the capacitor and ground, a third switch controlled by a signal present on a gate of said MOS transistor, applied between a second terminal of said capacitor and a prefixed reference voltage, a fourth switch controlled by said second control signal, applied to the second terminal of said capacitor and the gate of said MOS transistor, a fifth switch controlled by said first control signal, applied between the gate of said MOS transistor and ground.

6. A controlled switching circuit, comprising:
a first MOS transistor having source, drain, gate, and bulk terminals, the source and drain terminals being connected between an input and an output of the controlled switching circuit;
a first switch connected between the bulk terminal and a first reference voltage; and
a second switch connected between the bulk terminal and the input.

7. The controlled switching circuit of claim 6 wherein the second switch is connected between the source and bulk terminals.

8. The controlled switching circuit of claim 6 wherein the first switch is controlled by a first control signal and the second switch is controlled by a second control signal, the first and second control signals having non-overlapping active phases such that the second switch is open while the first switch is closed and the second switch is closed while the first switch is open.

9. The controlled switching circuit of claim 6 wherein the second switch includes complementary second and third MOS transistors connected in parallel between the bulk terminal of the first MOS transistor and the input, the second MOS transistor being controlled by a control signal and the third MOS transistor being controlled by an inverted form of the control signal.

10. The controlled switching circuit of claim 6, further comprising:
a capacitor having first and second terminals;
a third switch connected between the input and the first terminal of the capacitor;
a fourth switch connected between the second terminal of the capacitor and the gate terminal of the first MOS transistor; and
a fifth switch connected between the second terminal of the capacitor and a second reference voltage.

11. The controlled switching circuit of claim 10 wherein the fifth switch includes a control terminal connected to the gate of the first MOS transistor.

12. The controlled switching circuit of claim 10, further comprising:
a sixth switch connected between the first terminal of the capacitor and the first reference voltage, the fifth and sixth switches being controlled by a first control signal and the third and fourth switches being controlled by a second control signal, wherein the first and second control signals have non-overlapping active phases such that the third and fourth switches are open while the fifth and sixth switches are closed and the third and fourth switches are closed while the fifth and sixth switches are open.

13. The controlled switching circuit of claim 12, further comprising:
a seventh switch connected between the gate terminal of the first MOS transistor and the first reference voltage, the seventh switch having a control terminal connected to the first control signal such that the seventh switch is closed during the active phase of the first control signal, which connects a control terminal of the fifth switch to the first reference voltage and closes the fifth switch.

14. The controlled switching circuit of claim 10 wherein the fourth switch is an NMOS transistor having a bulk terminal and the fifth switch is a PMOS transistor with a bulk terminal connected to the bulk terminal of the fourth switch.

15. A method of controlling a MOS transistor having source, drain, gate, and bulk terminals, the method comprising:
opening the MOS transistor and connecting the bulk terminal to ground during a first phase; and
closing the MOS transistor and connecting the bulk terminal to one of the source and drain terminals during a second phase that does not overlap the first phase.

16. The method of claim 15 wherein the bulk and gate are respectively connected to ground by first and second switches and the bulk is connected to the one of the source and drain terminals by a third switch, the first and second switches being controlled by a first control signal and the third switch being controlled by a second control signal.

17. The method of claim 15, further comprising:
charging a capacitor to a reference voltage during the first phase; and
electrically connecting the capacitor to the gate terminal of the MOS transistor during the second phase.

18. The method of claim 17 wherein the charging step includes connecting a first terminal of the capacitor to ground and a second terminal of the capacitor to the reference voltage during the first phase and the electrically connecting step includes, during the second phase:
disconnecting the capacitor from ground and the reference voltage;
connecting the first terminal of the capacitor to an input voltage; and
connecting the second terminal of the capacitor to the gate terminal of the MOS transistor.

19. The method of claim 17 wherein the charging step includes connecting a first terminal of the capacitor to ground and a second terminal of the capacitor to the reference voltage via a first switch during the first phase, the first switch having a control terminal connected to ground via a second switch connected between the gate terminal of the MOS transistor and ground.
